(19) United States
(12) Patent Application Publication
(10) Pub. No.: US 2019/0147734 A1
(43) Pub. Date: May 16, 2019

(54) COLLABORATIVE MEDIA COLLECTION ANALYSIS

(71) Applicant: Honeywell International Inc., Morris Plains, NJ (US)

(72) Inventors: Satheesh Kumar Murugesan, Bangalore (IN); Sanjay Ramu, Bangalore (IN); Sekhar Kommoju, Bangalore (IN); Chandrakantha Reddy, Velgode (IN); Jayaprakash Meruva, Bangalore (IN)

(21) Appl. No.: 15/812,424

(22) Filed: Nov. 14, 2017

(51) Int. Cl. G08B 25/14; G06F 17/30; H04N 7/18; G06F 3/14; G06T 7/70

(52) U.S. Cl. CPC G08B 25/14; G06F 17/3082; G06T 7/70; G06F 3/14; H04N 7/181

(57) ABSTRACT

Methods, devices, and systems for collaborative media collection analysis are described herein. One device includes a memory, and a processor to execute executable instructions stored in the memory to receive an incident alert about an infrastructure related incident, receive media associated with the incident in response to receiving the incident alert, where the media is at least one of recorded media and real-time media, transmit the media associated with the incident to a plurality of mobile devices, and generate an incident file in response to receiving the incident alert, where the incident file includes the received media associated with the incident, and a user interface to display the generated incident file in a single integrated display.

### TECHNICAL FIELD

The present disclosure relates to methods, devices, and systems for collaborative media collection analysis.

### BACKGROUND

Building operations may include use of a security system. The security system may include cameras, such as closed circuit television (CCTV) cameras to view areas of the building. Security personnel may be utilized in combination with CCTV cameras.

An incident, such as an abnormal situation, may occur in and/or around the building. For example, a window may have been broken. The security system of the building may allow a building operator to access a CCTV camera to view an area around the broken window. In some examples, a building operator may send a security guard to investigate the incident and/or document the area around the incident.

The building operator can communicate with the security guard via mobile device, radio, and/or other forms of communication. The building operator may search for the CCTV camera using a list of cameras and/or a pre-configured camera views to view the area around an incident.

In some instances, a town and/or city may utilize CCTV cameras to view areas of the town and/or city. An incident may occur in the town and/or city, and a security system may allow police and/or other emergency responders (e.g., ambulance, fire, etc.) to view an area around the incident. The police and/or emergency responders may send personnel to investigate and/or respond to the incident.

### BRIEF DESCRIPTION OF THE DRAWINGS

FIG. 1 is an example of a system for collaborative media collection analysis, in accordance with one or more embodiments of the present disclosure.

FIG. 2 is an illustration of a display provided on a user interface showing a collaborative media collection analysis, generated in accordance with one or more embodiments of the present disclosure.

FIG. 3 is an illustration of a method for determining a particular CCTV camera, in accordance with one or more embodiments of the present disclosure.

FIG. 4 is an illustration of a display provided on a user interface showing objects detected by a CCTV camera in a surrounding area of the CCTV camera, in accordance with one or more embodiments of the present disclosure.

FIG. 5 is a computing device for collaborative media collection analysis, in accordance with one or more embodiments of the present disclosure.

### DETAILED DESCRIPTION

Methods, devices, and systems for collaborative media collection analysis are described herein. In some examples, one or more embodiments include a memory, and a processor to execute executable instructions stored in the memory to receive an incident alert about an infrastructure related incident, receive media associated with the incident in response to receiving the incident alert, where the media is at least one of recorded media and real-time media, transmit the media associated with the incident to a plurality of mobile devices, and generate an incident file in response to receiving the incident alert, where the incident file includes the received media associated with the incident, and a user interface to display the generated incident file in a single integrated display.

Collaborative media collection analysis, in accordance with the present disclosure, can allow a user, such as a building operator, to document incidents in and/or around a building. For example, a building operator can quickly search, using a search query, for a camera that can view the area around the incident and/or view media, such as audio and/or video, of the incident. The building operator may send security personnel to investigate the incident, and information such as audio and/or video exchanged between the security personnel and the building operator can be recorded and saved. The building operator may share video of the incident to the security personnel.

Collaborative media collection analysis, in accordance with the present disclosure, can allow for media associated with an incident to be recorded and stored. The media associated with the incident can be used in an incident file, which may include steps in a standard operating procedure (SOP) that may be generated to document the incident.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

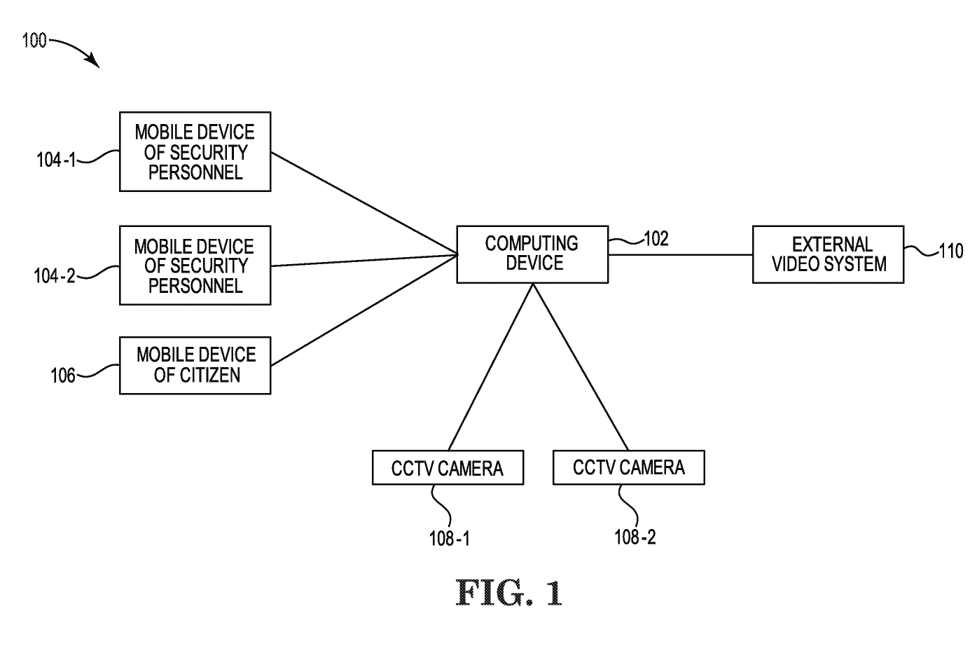

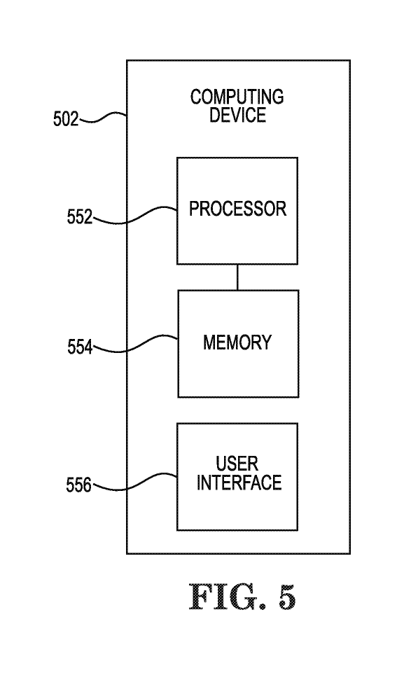

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 502 in FIG. 5.

FIG. 1 is an example of a system 100 for collaborative media collection analysis, generated in accordance with one or more embodiments of the present disclosure. As illustrated in FIG. 1, the system 100 can include a computing device 102, a mobile device of security personnel 104-1, 104-2, a mobile device of a citizen 106, a CCTV camera 108-1, 108-2, and an external video system 110.

Computing device 102 can receive an incident alert about an incident. As used herein, the term “incident” can, for example, refer to an abnormal situation. In some examples, an incident can include a security incident. For example, a security incident can refer to an incident involving in security, such as theft, destruction of property, vandalism, etc. For instance, a security incident can include a broken window, a vandalized wall, a break-in to a building, among other types of security incidents.

In some examples, an incident can include an incident relating to infrastructure. The infrastructure can be municipal infrastructure and/or building infrastructure. In some examples, a municipal infrastructure incident can include a leaking pipe, a malfunctioning traffic light, a damaged traffic sign, malfunctioning lighting, vandalism, among other types of municipal infrastructure incidents. In some examples, a building infrastructure incident can include a leaking pipe, broken heating, ventilation, and air-conditioning (HVAC) system or component of the HVAC system, malfunctioning lighting, among other types of building infrastructure incidents.

An incident alert can be received by computing device 102 in various ways. For example, an incident alert can be received by computing device 102 by a mobile device. For instance, a mobile device of a security personnel 104-1, 104-2 at a building may send an incident alert to computing device 102, and/or a mobile device of a citizen 106 may send an incident alert to computing device 102. The mobile devices 104-1, 104-2, 106 can send an incident alert to computing device 102 in response to a user input to the mobile devices 104-1, 104-2, 106. For example, a security guard may find an incident, such as a broken window, and may send an incident alert to computing device 102 based on a user input to the security guard's mobile device 104. As another example, a citizen may find an incident, such as a malfunctioning traffic light, and may send an incident alert to computing device 102 based on a user input to the citizen's mobile device 106.

As used herein, the term “mobile device” can, for example, refer to devices that are (or can be) carried and/or worn by a user. For example, mobile devices 104-1, 104-2, 106 can, for example, be a phone (e.g., a smart phone), a tablet, a personal digital assistant (PDA), smart glasses, and/or a wrist-worn device (e.g., a smart watch), among other types of mobile devices.

Although system 100 is illustrated as including mobile devices 104-1, 104-2 of security personnel and mobile device 106 of a citizen, examples of the disclosure are not so limited. For example, a mobile device of any other person (e.g., maintenance personnel, employees, custodial personnel, etc.) may be used to send an incident alert to computing device 102.

In some examples, an incident alert can be received by computing device 102 via a sensor, such as a building or other infrastructure sensor. For example, a smoke sensor may detect smoke and send an incident alert to computing device 102 indicating there may be a fire.

In some examples, an incident alert can be received by computing device 102 via a user. For example, the user may be viewing various CCTV cameras 108-1, 108-2 and view an incident. Based on the incident, computing device 102 can receive the incident alert from the user. For example, the user may input the incident alert into computing device 102 via a user input or send the incident alert to computing device 102 via a mobile device of the user.

As used herein, the term “CCTV” can, for example, refer to the use of video cameras to transmit a signal to a specific location on a set of monitors. As used herein, the term “video camera” can, for example, refer to a device for electronic motion picture acquisition.

The incident alert may be received by computing device 102 from a mobile device 104-1, 104-2, 106 and/or a sensor via a network. For example, the incident alert may be received by computing device 102 via a network relationship with mobile device 104-1, 104-2, 106 and/or a sensor. The network relationship can be a wired or wireless network.

The wired or wireless network can be a network relationship that connects mobile device 104-1, 104-2, 106 and/or a sensor to computing device 102. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, and/or the Internet, among other types of network relationships.

Computing device 102 can receive media associated with an incident in response to receiving the incident alert. As used herein, the term “media” can, for example, refer to audio, video, and/or images. In some examples, the media received by computing device 102 can be recorded media, such as recorded audio, video, and/or images. Recorded media can, for example, refer to media capturing past events. For example, recorded media can be media capturing an event, such as an incident, having occurred during a time previous to a present time.

In some examples, the media received by computing device 102 can be real-time media, such as real-time audio, video, and/or images. Real-time media can, for example, refer to media capturing present events. For example, real-time media can be media capturing an event, such as an incident, occurring at a present time.

The media can be received by computing device 102 from CCTV cameras 108-1, 108-2 and/or mobile devices 104-1, 104-2, 106. For example, security personnel, such as a security guard, can share audio, video, and/or images of an incident with a building operator using mobile device 104-1. For instance, the security guard may record or transmit real-time video of an incident to computing device 102 while discussing the incident with a building operator. The audio of the discussion of the incident can also be transmitted to computing device 102. The media can be transmitted to computing device 102 from mobile devices of security personnel, citizens, police officers, etc.

As another example, CCTV cameras 108-1, 108-2 can transmit recorded and/or real-time audio, video, and/or images of an incident to computing device 102. CCTV cameras 108-1, 108-2 can be security cameras, traffic cameras, mobile cameras such as temporary police cameras, etc., among other types of CCTV cameras.

The media can be received by computing device 102 via a network relationship. For example, the media can be received by computing device 102 via a network relationship with mobile device 104-1, 104-2, 106 and/or CCTV camera 108-1, 108-2. The network relationship can be a wired or wireless network.

The wired or wireless network can be a network relationship that connects mobile device 104-1, 104-2, 106 and/or CCTV camera 108-1, 108-2 to computing device 102. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, and/or the Internet, among other types of network relationships.

As described above, computing device 102 can receive audio, video, and/or images associated with an incident from a CCTV camera 108-1, 108-2. The audio, video, and/or images can be from a particular CCTV camera (e.g., CCTV camera 108-1). For example, CCTV camera 108-1 may be a CCTV camera that is associated with an incident. For instance, CCTV camera 108-1 may have captured media associated with an incident and/or may be a CCTV camera that is in an area associated with the incident.

In some examples, computing device 102 can receive audio from the CCTV camera 108-1, 108-2 that is recorded audio. For example, computing device 102 can receive audio from a past incident. In some examples, computing device 102 can receive audio from CCTV camera 108-1, 108-2 that is real-time audio. For example, computing device 102 can receive audio from a present incident from CCTV camera 108-1, 108-2.

In some examples, computing device 102 can receive video from the CCTV camera 108-1, 108-2 that is recorded video. For example, computing device 102 can receive video from a past incident. In some examples, computing device 102 can receive video from CCTV camera 108-1, 108-2 that is real-time video. For example, computing device 102 can receive video from a present incident from CCTV camera 108-1, 108-2.

Computing device 102 can receive audio, video, and/or images associated with an incident from a mobile device 104-1, 104-2, 106. The audio, video, and/or images can be from a particular mobile device (e.g., mobile device 104-2). For example, mobile device 104-2 may be a mobile device that is associated with security personnel, such as a security guard. For instance, the security guard may have captured audio, video, and/or images associated with an incident with the security guard's mobile device 104-2 as a result of the security guard investigating an incident.

In some examples, computing device 102 can receive audio from the mobile device 104-1, 104-2, 106 that is recorded audio. For example, computing device 102 can receive audio from a past incident. For instance, the security guard may record a statement from a witness about an incident with mobile device 104-2, and send the recorded statement to computing device 102. In some examples, computing device 102 can receive audio from mobile device 104-1, 104-2, 106 that is real-time audio. For example, computing device 102 can receive audio from a present incident from mobile device 104-1, 104-2, 106. For instance, a discussion between the security guard having mobile device 104-2 and a building operator about an incident can be recorded by computing device 102.

In some examples, computing device 102 can receive video from the mobile device 104-1, 104-2, 106 that is recorded video. For example, computing device 102 can receive video from a past incident. For instance, the security guard may record an area surrounding an incident with mobile device 104-2 to preserve the scene of the incident, and send the recorded video of the area surrounding the incident to computing device 102. In some examples, computing device 102 can receive video from mobile device 104-1, 104-2, 106 that is real-time video. For example, computing device 102 can receive video from a present incident from mobile device 104-1, 104-2, 106. For instance, the security guard may transmit real-time video of an area surrounding the incident with mobile device 104-2.

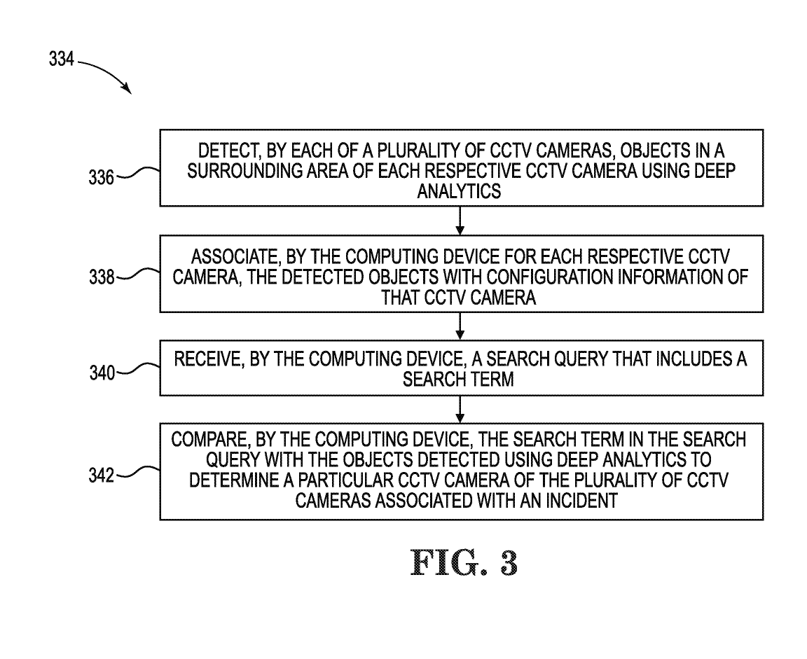

In some examples, computing device 102 can cause CCTV cameras 108-1, 108-2 to analyze a surrounding area of the CCTV cameras 108-1, 108-2 via deep analytics. As used herein, the term “deep analytics” can, for example, refer to data processing to yield information from large and/or multi-source data sets that may include structured, semi-structured, and/or unstructured data. For example, CCTV cameras 108-1, 108-2 can scan an area in the vicinity of the CCTV cameras 108-1, 108-2 in order to detect objects in the surrounding area. The objects can be, for example, objects in and/or around the surrounding area, such as doorways, fire escapes/fire exit doors, elevators, electrical boxes, fire equipment, notice boards, gates, bridges, roads, areas of a building (e.g., north hall, east wing, west wing, laboratory, etc.), parking ramp/car park entrances/exits, automatic teller machines (ATMs), among other examples of objects. The detected objects can be associated with configuration of each CCTV camera 108-1, 108-2 as is further described in connection with FIG. 3.

Computing device 102 can receive a search query of a CCTV camera 108-1, 108-2 associated with an incident. For example, a user, such as a building operator, may want to view a CCTV camera of an incident near a fire escape. Computing device 102 can utilize the search query to find the CCTV camera located near the fire escape. For instance, computing device 102 can determine CCTV camera 108-1 is located near the fire escape.

The CCTV camera 108-1, 108-2 can record audio and/or video associated with the incident. For example, computing device 102 can determine CCTV camera 108-1 is located near the fire escape at which an incident has occurred, and cause CCTV camera 108-1 to record audio and/or video. The audio and/or video may be utilized as part of an SOP used to document the incident, as described above.

The search query can be an input to computing device 102 and/or can be a voice command. For example, computing device 102 may receive the search query via an input device such as a mouse and/or keyboard, and/or may receive the search query via a touch-screen display having a graphical user interface (GUI), among other types of inputs. In some examples, computing device 102 may receive the search query as a voice command via a microphone. For example, a user may speak a voice command as a search query, and computing device 102 can receive the voice command search query via a microphone coupled to computing device 102.

The search query can include a search term. The search term can cause computing device 102 to identify the CCTV camera 108-1, 108-2 associated with the incident from a group of CCTV cameras. For example, a user can speak a voice command, “Show me cameras associated with fire escapes.” The search term can include “fire escapes”, and can cause computing device 102 to identify CCTV camera 108-1 is located near a fire escape at which an incident has occurred. Computing device 102 can identify the CCTV camera 108-1, 108-2 based on the search term by comparing the search term to objects detected by the CCTV camera 108-1, 108-2 via deep analytics, as is further described in connection with FIG. 3.

Computing device 102 can cause the CCTV camera 108-1, 108-2 associated with an incident to position CCTV camera 108-1, 108-2 to record the audio and/or video of the incident. For example, once computing device 102 has identified CCTV camera 108-1 based on the search term, computing device 102 can cause CCTV camera 108-1 to position itself to record audio and/or video associated with the incident and/or automatically position itself to the object included in the search query. For instance, CCTV camera 108-1 can include panning and/or zooming capabilities such that computing device 102 can cause CCTV camera 108-1 to pan and/or zoom in order to view and/or record audio and/or video associated with an incident. The pan and/or zoom of CCTV camera 108-1 can be in response to receiving the search query that includes the search term. For example, computing device 102 can cause CCTV camera 108-1 to position itself such that an object (e.g., a fire escape) is positioned in the video.

Computing device 102 can transmit media (e.g., recorded and/or real-time) associated with an incident to mobile devices 104-1, 104-2, 106. For example, computing device 102 can transmit audio, video, and/or images to mobile devices 104-1, 104-2, 106 associated with an incident. Continuing with the example above, an incident can occur near a fire escape. Computing device 102 can, for instance, transmit video from a CCTV camera 108-1 near the fire escape to mobile devices 104-1, 104-2 of security personnel investigating the area near the fire escape as a result of the incident. The video may help the security personnel investigate the incident and follow steps of an SOP to document the incident.

Although computing device 102 is described above as transmitting video from CCTV camera 108-1 to mobile devices 104-1, 104-2, embodiments of the present disclosure are not so limited. For example, media transmitted by computing device 102 to mobile devices 104-1, 104-2, 106 can be media from other sources. For instance, video received by computing device 102 from mobile device 106 of a citizen who may have happened upon the incident may be transmitted to mobile devices 104-1, 104-2 of security personnel investigating the incident.

Computing device 102 can transmit the media (e.g., recorded and/or real-time) associated with an incident to mobile devices 104-1, 104-2, 106 concurrently. For example, recorded video and/or real-time video from a CCTV camera 108-1 may be transmitted to mobile devices 104-1, 104-2 simultaneously. Further, while FIG. 1 illustrates three mobile devices 104-1, 104-2, 106, embodiments of the present disclosure are not so limited. For example, computing device 102 can transmit the media associated with an incident to more than three mobile devices concurrently or less than three mobile devices concurrently.

During transmission of media associated with an incident to mobile devices 104-1, 104-2, 106, computing device 102 can transmit a location of a CCTV camera 108-1, 108-2 that recorded the media received by computing device 102 associated with the incident. For instance, CCTV camera 108-1 may have recorded video of an incident near a fire escape, and transmitted the video to computing device 102. Computing device 102 can transmit the video recorded by CCTV camera 108-1 to mobile devices 104-1, 104-2, as well as the location of CCTV camera 108-1 to mobile devices 104-1, 104-2. The location of CCTV camera 108-1 and the video from CCTV camera 108-1 can help security personnel locate the fire escape where the incident occurred if, for example, the security personnel are unsure where the fire escape is or have become lost attempting to locate the fire escape.

Although described above as transmitting recorded media (e.g., video, audio, and/or images) by CCTV cameras 108-1, 108-2 to mobile devices 104-1, 104-2, 106, embodiments of the present disclosure are not so limited. For example, computing device 102 can transmit real-time media (e.g., real-time video, audio, and/or images) by CCTV cameras 108-1, 108-2 to mobile devices 104-1, 104-2, 106.

The locations of CCTV cameras 108-1, 108-2 can be predetermined locations. For example, a predefined location for CCTV camera 108-1 may be determined as near a fire escape when CCTV camera 108-1 is installed such that computing device 102 can include the predetermined location of CCTV camera 108-1. In some examples, the predetermined locations of CCTV cameras 108-1, 108-2 may be stored on computing device 102. In some examples, the predetermined locations of CCTV cameras 108-1, 108-2 may be stored external to computing device 102 (e.g., an external server) accessible by computing device 102 via a wired or wireless network.

During transmission of media associated with an incident to mobile devices 104-1, 104-2, 106, computing device 102 can transmit a location of a mobile device 104-1, 104-2, 106 that recorded the media received by computing device 102 associated with the incident. For instance, mobile device 106 may have recorded video of an incident near a fire escape, and transmitted the video to computing device 102. Computing device 102 can transmit the video recorded by mobile device 106 to mobile devices 104-1, 104-2, as well as the location of mobile device 106 to mobile devices 104-1, 104-2. The location of mobile device 106 and the video from mobile device 106 can help security personnel locate the fire escape where the incident occurred if, for example, the security personnel are unsure where the fire escape is or have become lost attempting to locate the fire escape.

The location of the mobile device 106 transmitted to mobile devices 104-1, 104-2 can be a location of the mobile device 106 when the mobile device 106 captured media associated with the incident, or a current location of mobile device 106 (e.g., if a user with mobile device 106 has moved locations since capturing the media associated with the incident). The current location of mobile device 106 may assist security personnel having mobile devices 104-1, 104-2 locate the user of mobile device 106 if, for instance, the security personnel have to take a statement from the user of mobile device 106 regarding the incident. The statement may be used as steps in an SOP regarding the incident.

The locations of mobile devices 104-1, 104-2, 106 can be determined using a global positioning system (GPS). For example, mobile devices 104-1, 104-2, 106 can include GPS functionality to allow computing device 102 to determine their location.

Although the locations of mobile devices 104-1, 104-2, 106 are described as being determined via GPS, embodiments of the present disclosure are not so limited. For example, the locations of mobile devices 104-1, 104-2, 106 may be determined via their connection to a wireless network, connection to a mobile network, among other examples of mobile device location.

Computing device 102 can modify a video resolution of video associated with an incident transmitted to a particular mobile device 104-1, 104-2, 106 in response to the particular mobile device 104-1, 104-2, 106 having a network connection quality below a predetermined threshold. For example, computing device 102 can modify a video resolution of video associated with an incident recorded by CCTV camera 108-1, 108-2 and/or mobile device 104-1, 104-2, 106 at a video resolution of 640×480 to 320×200 in response to a connection with mobile device 104-1 having a bandwidth below a predetermined threshold. In other words, CCTV camera 108-1, 108-2 and/or mobile device 104-1, 104-2, 106 can record a video of an incident at a video resolution of 640×480, and, in response to a connection with mobile device 104-1 having a bandwidth below a predetermined threshold, modify the video resolution of the video transmitted to mobile device 104-1 to 320×200.

Although network connection quality is described above as including bandwidth, embodiments of the present disclosure are not so limited. For example, network connection quality can include bandwidth, throughput, latency, jitter, and/or error rate, among other performance measures of network connection quality.

Computing device 102 can modify an audio quality of audio associated with an incident transmitted to a particular mobile device 104-1, 104-2, 106 in response to the particular mobile device 104-1, 104-2, 106 having a network connection quality below a predetermined threshold. For example, computing device 102 can modify a quality of audio associated with an incident recorded by CCTV camera 108-1, 108-2 and/or mobile device 104-1, 104-2, 106 by compressing the audio data of the audio in response to a connection with mobile device 104-1 having a bandwidth below a predetermined threshold. In other words, CCTV camera 108-1, 108-2 and/or mobile device 104-1, 104-2, 106 can record audio of an incident, and, in response to a connection with mobile device 104-1 having a bandwidth below a predetermined threshold, compress the audio transmitted to mobile device 104-1.

Although computing device 102 is described above as modifying a video resolution or an audio quality of video or audio associated with an incident, respectively, embodiments of the present disclosure are not so limited. For example, computing device 102 can modify both a video resolution and an audio quality of video or audio associated with an incident, respectively.

Computing device 102 can modify the video resolution of video and/or audio quality of audio transmitted to a particular mobile device 104-1, 104-2, 106 in response to the particular mobile device 104-1, 104-2, 106 having a network connection quality below a predetermined threshold in order to provide better video resolution of video and/or audio quality of audio to other mobile devices 104-1, 104-2, 106. For example, computing device 102 can modify video resolution of video transmitted to mobile device 104-1 in response to mobile device 104-1 having a network connection quality with computing device 102 below a predetermined threshold in order to provide better video resolution of the video transmitted to mobile devices 104-2, 106.

Computing device 102 can transmit video associated with an incident to an external video system 110. In some examples, the external video system 110 can be an Internet Protocol based video system. For example, video (e.g., recorded and/or real-time) may be transmitted by computing device 102 to Internet Protocol based video systems such as Skype, WebRTC, etc.

Computing device 102 can generate an incident file in response to receiving the incident alert. The incident file can include media received by computing device 102 associated with the incident. For example, media received by computing device 102 that can be included in the incident file can include recorded and/or real-time media, such as recorded audio, video, and/or images, as well as real-time audio, video, and/or images.

As described above, an incident file may include steps in an SOP that may be generated to document the incident. For example, an incident may include a fire alarm being pulled near a fire escape. Steps in the SOP to document the fire alarm being pulled may include determining who pulled the fire alarm (e.g., checking CCTV video cameras, questioning witnesses, video from mobile devices, etc.), why the fire alarm was pulled (e.g., smoke was present, flames were present, vandalism, etc.), among other steps of an SOP.

Computing device 102 can associate the recorded media and/or real-time media (e.g., from CCTV cameras 108-1, 108-2, mobile devices 104-1, 104-2, 106, etc.) with steps of the SOP. For example, CCTV camera 108-1 may record video of a person pulling the fire alarm, which may be associated with the SOP step of “who pulled the fire alarm”. Video recorded by mobile device 104-2 of a witness explaining why the person pulled the fire alarm may be associated with the SOP step of “why the fire alarm was pulled”. The steps of the SOP may be followed in order to close the incident.

Computing device 102 can include a user interface to display the collaborative media collection analysis in a single integrated display, as is further described in connection with FIG. 5. For example, the user interface can display the incident file, media from CCTV camera 108-1, 108-2, media from mobile device 104-1, 104-2, 106, etc.

Collaborative media collection analysis, according to the present disclosure, can allow users to generate media evidence, such as audio, video, and/or images, in order to investigate incidents and follow SOP's in order to respond to incidents and close incident files. Media can be concurrently shared with mobile devices in order to enable smart decision making by allowing collaboration between citizens, security personnel, law enforcement, building operators, and/or city managers, among other collaborative groups, leading to safer and/or more secure buildings and cities.

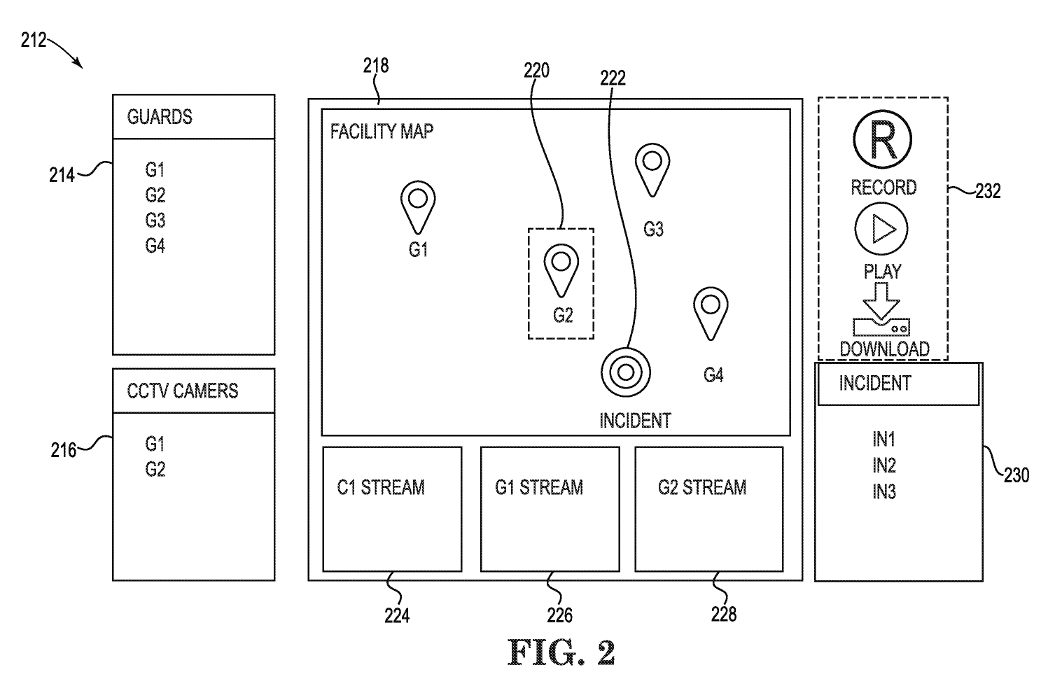

FIG. 2 is an illustration of a display 212 provided on a user interface showing a collaborative media collection analysis, generated in accordance with one or more embodiments of the present disclosure. The collaborative media collection analysis display 212 can include security personnel 214, CCTV cameras 216, facility map 218, media from CCTV camera C1 224, media from mobile device of security personnel G1 226, media from mobile device of security personnel G2 228, incident files 230, and media control 232. Facility map 218 can include location of security personnel G2 220 and location of incident 222.

Displaying an incident file of incident files 230 can include displaying locations at which recorded media and/or real-time media originated. For example, an incident may have occurred in the facility as shown in facility map 218. The location of incident 222 can be shown in facility map 218, as well as the location of security personnel G2 220.

As an example, the incident can include a fire alarm that was pulled in the facility. The location of the incident 222 can correspond to the location of the fire alarm, as illustrated by facility map 218. A building operator can view facility map 218 to identify the location of the incident 222 and can, for example, send security personnel 214 to investigate the pulled fire alarm.

A building operator can view CCTV camera video of the incident. For example, the building operator can give a computing device a search query via a voice command, such as “show me CCTV cameras showing fire alarms”, or the search query can be entered via a touch screen GUI, entered via computing device peripherals such as a mouse/keyboard, etc. The computing device can identify, based on the search query (e.g., based on search query terms and objects located by cameras, as previously described in connection with FIG. 1 and further described in connection with FIG. 3), that CCTV cameras 216 show fire alarms. That is, CCTV cameras C1 and C2 show fire alarms.

The building operator can select CCTV camera C1 to view media from CCTV camera C1 224 (e.g., media received by the computing device from CCTV camera C1 224). For example, CCTV camera C1 can show media (e.g., audio, video, and/or images) that may be recorded and/or real-time associated with the incident. For instance, the building operator can view recorded video of a person pulling the fire alarm, and/or can view real-time video of the area surrounding the fire alarm.

Security personnel 214 can each carry a mobile device that can include a respective location. For example, the location of the mobile device of security personnel G2 can be shown by facility map 218. In some examples, the location of the mobile device of each of the security personnel 214 can be determined via GPS, as previously described in connection with FIG. 1.

The building operator can transmit the media of CCTV camera C1 224 to the mobile device of security personnel G2. For example, the building operator can transmit recorded video and/or real-time video of CCTV camera C1 to the mobile device of security personnel G2 so that security personnel G2 can investigate and document the incident.

The building operator can concurrently transmit the media of CCTV camera C1 224 to the mobile device of security personnel G2 and to the mobile device of security personnel G1. For example, the building operator can transmit recorded video and/or real-time video of CCTV camera C1 to the mobile device of security personnel G2 and to the mobile device of security personnel G1 so that security personnel G2 and G1 can investigate and document the incident.

In some examples, security personnel G1 may have media associated with an incident. For instance, security personnel G1 may interview a witness associated with the pulled fire alarm. The media, such as audio, video, and/or images, can be transmitted from the mobile device of security personnel G1 to the computing device. The building operator can view the media from security personnel G1 226.

The recorded media of the witness interview can be transmitted to the mobile device of security personnel G2. For instance, the building operator can, via the computing device, cause the media of the witness interview to be transmitted to the mobile device of security personnel G2 so that security personnel G2 can investigate and document the pulled fire alarm.

The collaborative media collection analysis display 212 can include media control 232. For example, a building operator can select the media from CCTV camera C1 224 from CCTV cameras 216 and record the media. The computing device can, in some examples, replay recorded media. Further, the computing device can download media and, for instance, transmit media to other video systems such as an Internet Protocol based video system.

FIG. 3 is an illustration of a method 334 for determining a particular CCTV camera, generated in accordance with one or more embodiments of the present disclosure. The method 334 can be performed by a computing device (e.g., computing device 102, 502, described in connection with FIGS. 1 and 5, respectively).

At 336, the method 334 can include detecting, by each of a plurality of CCTV cameras (e.g., CCTV cameras 108-1, 108-2, previously described in connection with FIG. 1), objects in a surrounding area of each respective CCTV camera using deep analytics. The surrounding area of a CCTV camera can be, for instance, a field of view of the CCTV camera. In some examples, the field of view of a CCTV camera can be 360°. That is, the CCTV camera can rotate to capture a 360° field of view. The objects can be detected in and/or around the surrounding area in the CCTV camera's field of view and can include, for example, doorways, fire escapes/fire exit doors, fire alarms, elevators, electrical boxes, fire equipment, notice boards, gates, bridges, roads, areas of a building (e.g., north hall, east wing, west wing, laboratory, etc.), parking ramp/car park entrances/exits, automatic teller machines (ATMs), among other examples of objects.

A CCTV camera can utilize deep analytics to detect objects in the surrounding area of the CCTV camera. The CCTV camera can use deep analytics to detect objects by detecting colors, textures, shapes, motion, etc.

In some examples, the CCTV camera can use deep analytics to detect objects using colors by detecting color characteristics. Color characteristics can include a dominant color, a scalable color, a color layout, a color structure, a group-of-frames (GoF) or group-of-pictures (GoP) color, among other color characteristics.

In some examples, the CCTV camera can use deep analytics to detect objects using texture by detecting texture characteristics of objects. Texture characteristics can include homogeneous textures, texture browsing, edge histograms, among other texture characteristics.

In some examples, the CCTV camera can use deep analytics to detect objects using shapes by detecting shape characteristics of objects. Shape characteristics can include region shapes, contour shapes, three-dimensional (3D) shapes, among other shape characteristics.

In some examples, the CCTV camera can use deep analytics to detect objects using motion by detecting motion characteristics of objects. Motion characteristics can include camera motion, motion trajectory, parametric motion, motion activity, among other motion characteristics.

Although the CCTV camera is described above as detecting objects using deep analytics including detecting objects using colors, texture, shapes, and/or motion, examples of the present disclosure are not so limited. For example, a CCTV camera may record a field of view around the CCTV camera and transmit the video of the field of view to a remote computing device (e.g., such as a remote server in a cloud computing environment). The remote computing device can utilize the recorded video of the field of view of the CCTV camera in order to detect objects using colors, texture, shapes, and/or motion via deep analytics. The resultant deep analytics analysis can be transmitted to the CCTV camera such that the CCTV camera can locally store the resultant deep analytics analysis.

At 338, the method 334 can include associating, by the computing device for each respective CCTV camera, the detected objects with configuration information of that CCTV camera. Configuration information can include, for instance, CCTV camera names, camera numbers, camera streamer types, camera locations, camera present/tour/pattern names, camera descriptions, and/or camera types, user configured camera labels/tags, camera status (e.g., Failed/Ok/Motion/Tamper, etc.), among other configuration information.

For example, configuration information for a CCTV camera located near a fire escape may include a camera name (e.g., Fire_Escape230), a camera number (e.g., CCTV camera 230), a camera location (e.g., West Hall Fire Escape), camera status (e.g., Camera Ok), etc.

At 340, the method 334 can include receiving, by the computing device, a search query that includes a search term. For example, a user of the computing device may wish to view a CCTV camera of an incident near a fire escape. The user of the computing device may input a search query including a search term into the computing device to search for CCTV cameras associated with the incident near the fire escape. The search query can be input to the computing device by a voice command, by an input device of the computing device such as a mouse and/or keyboard, and/or via a GUI of a touch screen display, among other types of input devices.

The search query can include a search term. The search term can cause the computing device to identify the CCTV camera associated with an incident. For example, the user can speak, via a voice command, or enter the search query by an input device of the computing device “Show me cameras associated with fire escapes.” The search term can be “fire escapes”.

At 342, the method 334 can include comparing, by the computing device, the search term in the search query with the objects detected using deep analytics to identify a particular CCTV camera of the plurality of CCTV cameras associated with an incident. For example, the computing device can compare the search term “fire escapes” with objects determined to be fire escapes detected using deep analytics. For instance, the computing device can determine that CCTV cameras 1 and 2 detected fire escapes using deep analytics, and CCTV cameras 3-10 did not detect fire escapes during deep analytics. In response, the computing device can cause media, such as audio, video, and/or images from CCTV cameras 1 and 2 to be displayed.

Utilizing deep analytics to detect objects using CCTV cameras can allow building operators to quickly and easily find CCTV cameras that are relevant to a particular situation (e.g., incident or an object in the vicinity of a particular CCTV camera that may be included in a search query as a search term). A user can search for relevant CCTV cameras using plain words rather than scrolling through lists of CCTV cameras that may not be relevant to the particular situation. Large CCTV camera networks can include many different CCTV camera media. A user can more easily and quick search for the relevant CCTV camera and more quickly respond to incidents.

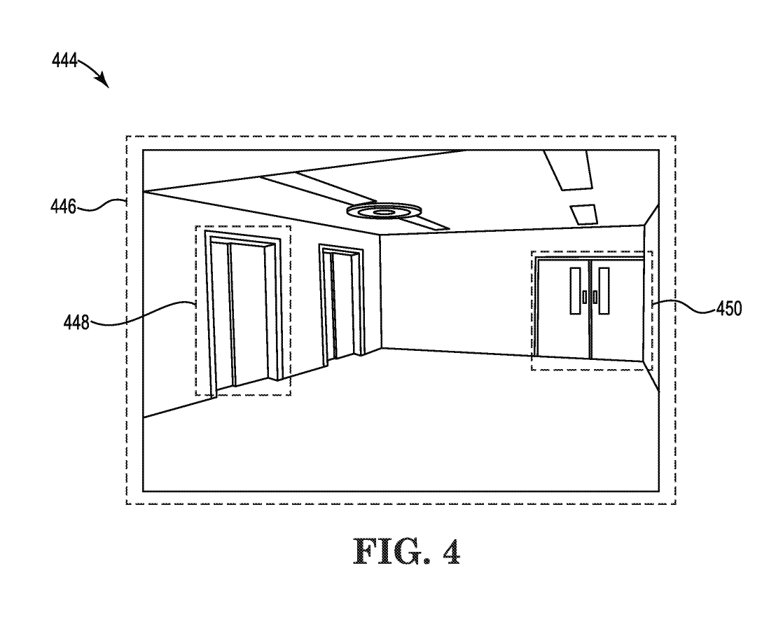

FIG. 4 is an illustration of a display 444 provided on a user interface showing objects 448, 450 detected by a CCTV camera in a surrounding area 446 of the CCTV camera, in accordance with one or more embodiments of the present disclosure. As illustrated in FIG. 4, the display 444 can include surrounding area 446. The surrounding area 446 can include elevator 448 and hallway doors 450.

As previously described in connection with FIGS. 1 and 3, a computing device (e.g., computing device 102, 502, described in connection with FIGS. 1 and 5, respectively) can cause a plurality of CCTV cameras to analyze a surrounding area 446 via deep analytics to identify a CCTV camera of the plurality of CCTV cameras associated with an incident. For example, a CCTV camera can analyze surrounding area 446 to detect objects such as elevator 448 and hallway doors 450.

As previously described in connection with FIG. 3, the CCTV camera can utilize deep analytics to detect objects by detecting colors, textures, shapes, motion, etc. The objects can be localized in the CCTV camera field of view by, for instance, regional locators and/or spatio-temporal locators.

For example, a CCTV camera my utilize deep analytics as described in connection with FIG. 3 to define objects such as elevator 448 and hallway doors 450. Deep analytics results may include results in the form such as the following:

```
<MediaRef URI=“DVMServer1\Camera_HallExit234” PTZ
Direction=“x,y,z″ />
<Objects>
<Object type = “Elevator” trackId=1>
  <CoordRef type=“Rectangle”> 158 267 3 23 </CoordRef>
  <DominantColor> Silver</ DominantColor >
</Object>
<Object type = “Hallway Doors” trackId=2>
  <CoordRef type=“Rectangle”> 59 192 3 99 </CoordRef>
  <DominantColor> Black <DominantColor>
  <ContinuousMotion> no </Occluded>
</Object>
</Objects>
```

where the name of the camera is “Camera_HallExit234” and the camera has detected two objects: an elevator and hallway doors. Utilizing the results of the deep analytics, the computing device can associate the detected objects with configuration information of the CCTV camera, as previously described in connection with FIG. 3.

In response to receiving a search query, the computing device can compare a search term included in the search query to cause the computing device to identify a CCTV camera associated with an incident. For example, the search query can include a search term “Elevator doors”. The computing device can determine that the camera “Camera_HallExit234” detected elevator doors as an object and can display media from camera “Camera_HallExit234”.

FIG. 5 is a computing device 502 for collaborative media collection analysis, in accordance with one or more embodiments of the present disclosure. As illustrated in FIG. 5, computing device 502 can include a user interface 556, memory 554 and a processor 552 for collaborative media collection analysis in accordance with the present disclosure.

The memory 554 can be any type of storage medium that can be accessed by the processor 552 to perform various examples of the present disclosure. For example, the memory 554 can be a non-transitory computer readable medium having computer readable instructions (e.g., computer program instructions) stored thereon that are executable by the processor 552 for collaborative media collection analysis in accordance with the present disclosure. The computer readable instructions can be executable by the processor 552 to redundantly generate the collaborative media collection analysis.

The memory 554 can be volatile or nonvolatile memory. The memory 554 can also be removable (e.g., portable) memory, or non-removable (e.g., internal) memory. For example, the memory 554 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 554 is illustrated as being located within computing device 502, embodiments of the present disclosure are not so limited. For example, memory 554 can also be located internal to another computing resource (e.g., enabling computer readable instructions to be downloaded over the Internet or another wired or wireless connection).

As illustrated in FIG. 5, computing device 502 includes a user interface 556. For example, the user interface 556 can display collaborative media collection analysis (e.g., as previously described in connection with FIGS. 1-4) in a single integrated display. A user (e.g., operator) of computing device 502 can interact with computing device 502 via user interface 556. For example, user interface 556 can provide (e.g., display and/or present) information to the user of computing device 502, and/or receive information from (e.g., input by) the user of computing device 502. For instance, in some embodiments, user interface 556 can be a graphical user interface (GUI) that can provide and/or receive information to and/or from the user of computing device 502. The display can be, for instance, a touch-screen (e.g., the GUI can include touch-screen capabilities). Alternatively, a display can include a television, computer monitor, mobile device screen, other type of display device, or any combination thereof, connected to computing device 502 and configured to receive a video signal output from the computing device 502.

As an additional example, user interface 556 can include a keyboard and/or mouse the user can use to input information into computing device 502. Embodiments of the present disclosure, however, are not limited to a particular type(s) of user interface.

User interface 556 can be localized to any language. For example, user interface 556 can display the aircraft stand management in any language, such as English, Spanish, German, French, Mandarin, Arabic, Japanese, Hindi, etc.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for collaborative media collection analysis, comprising:
a memory;
a processor configured to execute executable instructions stored in the memory to:
receive an incident alert about an infrastructure related incident;
receive media associated with the incident in response to receiving the incident alert, wherein the media is at least one of recorded media and real-time media;
transmit the media associated with the incident to a plurality of mobile devices; and
generate an incident file in response to receiving the incident alert, wherein the incident file includes the received media associated with the incident; and
a user interface configured to display the generated incident file in a single integrated display.

2. The computing device of claim 1, wherein the processor is configured to execute the instructions to transmit the media associated with the incident to the plurality of mobile devices concurrently.

3. The computing device of claim 1, wherein the processor is configured to execute the instructions to receive the media associated with the incident from at least one of:
a plurality of closed-circuit television (CCTV) cameras; and
the plurality of mobile devices.

4. The computing device of claim 1, wherein the instructions to receive the media associated with the incident include instructions to receive at least one of audio, video, and images associated with the incident from a mobile device of the plurality of mobile devices.

5. The computing device of claim 4, wherein:
the audio from the mobile device is at least one of a recorded audio and real-time audio; and
the video from the mobile device is at least one of a recorded video and real-time video.

6. The computing device of claim 1, wherein the instructions to receive the media associated with the incident include instructions to receive at least one of audio, video, and images associated with the incident from a CCTV camera of a plurality of CCTV cameras.

7. The computing device of claim 6, wherein:
the audio from the CCTV camera is at least one of a recorded audio and real-time audio; and
the video from the CCTV camera is at least one of a recorded video and real-time video.

8. The computing device of claim 1, wherein the instructions to transmit the media associated with the incident to the plurality of mobile devices include instructions to transmit a location of a mobile device of the plurality of mobile devices that recorded the received media associated with the incident alert being transmitted to the plurality of mobile devices.

9. The computing device of claim 1, wherein the instructions to transmit the media associated with the incident to the plurality of mobile devices include instructions to transmit a location of a CCTV camera of a plurality of CCTV cameras that recorded the received media associated with the incident alert being transmitted to the plurality of mobile devices.

10. The computing device of claim 1, wherein the processor is configured to execute the instructions to cause a plurality of CCTV cameras to analyze a surrounding area via deep analytics to identify a CCTV camera of the plurality of CCTV cameras associated with the incident.

11. A non-transitory computer readable medium having computer readable instructions stored thereon that are executable by a processor to:
receive media associated with an incident related to infrastructure, wherein the media includes at least one of recorded media and real-time media;
receive a search query for a closed-circuit television (CCTV) camera associated with the incident that causes the CCTV camera to record at least one of audio and video associated with the incident;
concurrently transmit, to a plurality of mobile devices in response to the incident alert, at least one of:
the received media associated with the incident; and
the at least one of the audio and video associated with the incident recorded by the CCTV camera;
generate an incident file in response to receiving the incident alert; and
display the incident file, the received media, and the audio and video associated with the incident recorded by the CCTV camera.

12. The computer readable medium of claim 11, wherein the search query includes a search term that causes the computer readable instructions to be executed by the processor to identify the CCTV camera associated with the incident from a plurality of CCTV cameras.

13. The computer readable medium of claim 11, wherein the computer readable instructions are executable by the processor to cause the CCTV camera associated with the incident to position the CCTV camera to record the at least one of the audio and video associated with the incident.

14. The computer readable medium of claim 11, wherein the computer readable instructions are executable by the processor to modify at least one of an audio quality of the audio and a video resolution of the video associated with the incident transmitted to a particular mobile device of the plurality of mobile devices in response to the particular mobile device having a network connection quality below a predetermined threshold.

15. The computer readable medium of claim 11, wherein the computer readable instructions are executable by the processor to transmit the video associated with the incident to an Internet Protocol based video system.

16. A computer implemented method for collaborative media collection analysis, comprising:
receiving, by a computing device, at least one of recorded and real-time media associated with an incident related to infrastructure associated with a building;
receiving, by the computing device, a search query for a particular closed-circuit television (CCTV) camera associated with the incident;
identifying, in response to the search query, the particular CCTV camera associated with the incident from a plurality of CCTV cameras of the building;
transmitting, by the computing device:
the recorded media associated with the incident;
the real-time media associated with the incident; and
media from the particular CCTV camera associated with the incident;
generating, by the computing device, an incident file in response to receiving the incident alert; and
displaying, on a user interface of the computing device, at least one of the incident file, the media from the particular CCTV camera, and the received media associated with the incident.

17. The method of claim 16, wherein the method includes:
detecting, by each of the plurality of CCTV cameras, objects in a surrounding area of each respective CCTV camera using deep analytics; and
associating, by the computing device for each respective CCTV camera, the detected objects with configuration information of that CCTV camera.

18. The method of claim 17, wherein determining the particular CCTV camera associated with the incident includes comparing a search term included in the search query with the objects detected via deep analytics.

19. The method of claim 16, wherein generating the incident file includes associating the recorded media, the real-time media, and the media from the particular CCTV camera associated with the incident with steps of a standard operating procedure (SOP) to close the incident file.

20. The method of claim 16, wherein displaying the incident file includes displaying locations at which the recorded media, the real-time media, and the media from the particular CCTV camera associated with the incident originated on the user interface.
